(19) United States
(12) Patent Application Publication
(10) Pub. No.: US 2025/0029231 A1
(43) Pub. Date: Jan. 23, 2025

(54) METHOD FOR ADJUSTMENT OF A COMPONENT

(71) Applicant: VOITH PATENT GMBH, Heidenheim (DE)

(72) Inventors: Jose Luiz CAMPOS SOUZA, Heidenheim (DE); Marc ERKELENZ, Neu-Ulm (DE); Marc-Oliver STENITSCHKA, Syrgenstein (DE)

(21) Appl. No.: 18/910,094

(22) Filed: Oct. 9, 2024

Related U.S. Application Data
(63) Continuation of application No. PCT/EP2023/058914, filed on Apr. 5, 2023.

(30) Foreign Application Priority Data
Apr. 11, 2022 (DE) 10 2022 108 709.3

(51) Int. Cl. G06T 7/00; D21G 9/00; G06F 3/01

(52) U.S. Cl. CPC G06T 7/0006; D21G 9/0009; G06F 3/017; G06T 2207/30164; G06T 2207/30204

(57) ABSTRACT

A method for adjusting a component, in particular a functional roller, for a machine for producing or processing a fibrous web, is carried out on a component having at least one adjustment device for adjusting an operating state of the component. An image capture and/or video capture of the exterior of the component is carried out and the capture is transmitted to a computing unit. An actual value of the operating state is determined by the computing unit by image analysis of the image capture and/or video capture of the exterior of the component and/or by the acquisition of values from an embedded sensor system. On the basis of the determined actual values of the operating state, metainformation regarding the adjustment of the adjustment device is presented by overlay with the image capture and/or video capture on a display.

### CROSS-REFERENCE TO RELATED APPLICATION

This application is a continuation, under 35 U.S.C. § 120, of copending International Patent Application PCT/EP2023/058914, filed Apr. 5, 2023, which designated the United States; this application also claims the priority, under 35 U.S.C. § 119, of German Patent Application DE 10 2022 108 709.3, filed Apr. 11, 2022; the prior applications are herewith incorporated by reference in their entirety.

### FIELD AND BACKGROUND OF THE INVENTION

The invention relates to a method for adjusting a component, in particular a functional roller, for a machine for the production or processing of a fibrous web, wherein the component includes at least one adjustment device for setting an operating state of the component.

In machines for the production or processing of a fibrous web, in particular in paper machines, numerous components are used that need to be adjusted or adapted during the plant operation, depending on the current production conditions. Those components include a variety of functional rollers, such as suction rollers, spreader rollers, deflection compensating rollers, or also shoe presses, for example. In order to achieve that adjustment, those components are equipped with corresponding adjustment devices.

However, operating the adjustment devices is often not intuitive. For example, in the case of suction rollers, the positions of the internal suction box and sealing strips can be changed from the outside by a mechanical adjustment. Suction rollers of that kind, as well as the adjustable sealing strips and format limiters, are described in German Patent Application DE 10 2009 000 371 or European Patent EP 2707544 B1, corresponding to U.S. Pat. No. 10,344,864 B2 and U.S. Publication No. 2014/0070495, for example. The position of the sealing strips, and therefore the positioning of the region of the roller cover where the vacuum is applied, is important in the case of suction press rollers, for example, in order to ensure optimal dewatering of the paper web. Incorrect positioning of the suction box can result in the dryness of the fibrous web being 1-2% lower than with optimal positioning, representing a significant efficiency loss for the press. However, it is not directly apparent where exactly the current position of the suction box or the strips is, nor what effect the adjustment will have. An assessment is usually carried out indirectly by observing and evaluating the effects achieved by the adjustment.

Therefore, an adjustment of that kind often requires the use of appropriately trained and experienced personnel. However, the use of those qualified specialists is costly. In addition, the availability of such personnel represents a bottleneck.

In German Patent Application DE 10 2021 104 870, corresponding to U.S. Publication No. 2024/0125049 A1, the Applicant of the instant application describes a method of making the internal, non-visible sealing strips and format limiters of suction rollers visible by using Augmented Reality (AR), thereby providing the operator with valuable guidance in adjusting the strip positions.

However, there is a need to further simplify the adjustment process for suction rollers. Furthermore, there is a need to simplify the optimal, and also reproducible, adjustment of components in a paper machine for the operating personnel, in particular in the case of other functional rollers.

### SUMMARY OF THE INVENTION

It is accordingly an object of the invention to provide a method for adjustment of a component, which overcomes the hereinafore-mentioned disadvantages of the heretofore-known methods of this general type.

The object is achieved according to the invention by an embodiment corresponding to the independent claim. Further advantageous embodiments of the present invention can be found in the dependent claims.

With the foregoing and other objects in view there is provided, in accordance with the invention, a method for adjusting a component, in particular a functional roller, for a machine for the production or processing of a fibrous web, wherein the component includes at least one adjustment device for setting an operating state of the component, the method comprising the following steps:
carrying out an image and/or video capture of the exterior of the component and transmitting the capture to a computing unit;
determining an actual value of the operating state by using the computing unit by analyzing the image and/or video capture of the exterior of the component and/or by acquiring values from an embedded sensor system; and
based on the determined actual values of the operating state: presenting metadata for adjusting the adjustment device by overlaying it with the image and/or video capture on a display.

It may be provided that the actual value of the operating state is determined solely from the image or video capture of the component. This is particularly advantageous for components whose form allows conclusions to be very easily drawn about their current settings.

Alternatively, it may also be provided that a marker element is attached to the exterior of the component or in the immediate vicinity thereof at a defined position, and that this marker element is also captured during the image and/or video capture.

The marker element may, for example, be a specially shaped geometric object that can be reliably recognized and uniquely identified by image analysis. Based on the position of the marker element, the actual value of the operating state, for example the exact positioning of a functional roller, can then be determined.

In this case, the marker element can either remain permanently attached to the respective component or also be constructed in such a manner that it can easily be removed. This means that it can be taken off again after the component has been adjusted and does not interfere with the further operation of the machine. Equally, the marker element does not get unnecessarily dirty, which could otherwise hinder recognition and lead to inaccuracies. Another advantage is that the marker element cannot cause damage if it becomes accidentally detached.

The image analysis and/or determination of the actual value can advantageously be performed on the computing unit in real-time or with a slight time lag (e.g. less than 10 seconds). In this way, the metadata is directly available to the operator on the display.

The setting of the adjustment device can then be carried out by the operating personnel or automatically via a control system.

Often, the process will be iterative. After adjusting the adjustment device, another image and/or video capture of the component's exterior can be created, and a new actual value for the operating state of the component can be determined. Based on the newly determined actual values, a renewed display of metadata for adjusting the adjustment device by overlaying it with the image and/or video capture on a display can be provided, in case the initial adjustment did not lead to the desired outcome.

These iterative steps can be carried out two, three, or more times, as needed.

Furthermore, it may be advantageous to provide a database system, and the computing unit can access this database system to determine the metadata. It is particularly advantageous in this case if the component has an ID tag, for example in the form of a QR code or an RFID chip. This ID tag can advantageously be captured using the same device used to capture the image or video. This may be, in particular, a smartphone, tablet, or similar device.

Using the ID tag of the component, further information about this component can be retrieved from the database system and also factored into the determination of the actual state.

It is also possible for the actual value of the operating state to be stored in the database system. The ID tag is also advantageous for this purpose.

The metadata displayed on the display can either be calculated by the, or a, computing unit using a stored algorithm or other appropriate relationships. Alternatively, or in addition, historical or optimal values can also be stored in a database system. The provision of the metadata can then be made by comparison with the stored historical values.

In order to improve the quality of the metadata, it may also be possible for a trained operator to directly correct the stored historical values. If it turns out during the adjustment of a component that the adjustment parameters provided by the metadata do not lead to the desired optimal result (which can happen due to wear or poorly executed maintenance work, for example), an experienced expert can manually make the optimal adjustment. Advantageously, the new optimal values can then be transmitted by the computing unit to the database system and stored there as the new standard. In this way, a learning system can be created with little effort, and even inexperienced operators can access the current technical knowledge of the experts.

Other operating parameters of the machine, such as product information, production speed, raw material data, quality parameters, sensor data, etc., are preferably also stored in the database system. As a result, the quality of the metadata can usually be substantially improved, as the optimal settings can vary depending on these operating parameters in many applications.

The proposed methods include aspects of Augmented Reality (AR).

In the reality-virtuality continuum (according to Paul Milgram et al, 1994), augmented reality (AR) and augmented virtuality are part of the so-called mixed reality. While the term augmented virtuality is rarely used by those skilled in the art, augmented reality and mixed reality, sometimes also referred to as enhanced reality, are often used synonymously. In contrast to virtual reality, where the user is completely immersed in a virtual world, the focus in augmented reality is on the presentation of additional information. For the visual modality, this leads to significantly stricter requirements for position determination (tracking) and calibration.

An AR system (abbreviated to ARS) refers to the system of technical components that are necessary to build an augmented reality application: camera, tracking devices, support software, etc.

The literature generally uses the definition of augmented reality by Azuma:
(http://www.cs.unc.edu/˜azuma/ARpresence.pdf).
Virtual reality and reality are combined (partially overlaid).
Interactivity in real-time.
Real and virtual objects are related to each other in a 3-dimensional space.
Source: Wikipedia (https://de.wikipedia.org/wiki/Erweiterte_Realitst)

Methods according to aspects of the invention can be used with a plurality of components. The method is in particular suitable for the various rollers that can be used in a paper machine—and particularly for functional rollers in this case.

However, a method according to aspects of the invention can also be applied to components that are not rollers.

### Application 1: Suction Rollers—Virtual Adjustment of the Suction Box

It can be provided that the component is a suction roller. A suction roller of this kind has a suction box inside it, as well as an adjustment device for setting the position of the suction box. The suction box can usually be moved or rotated so that a different circumferential region of the suction roller is subjected to suction.

For the adjustment, the actual values of the position of the suction box are determined based on the image and/or video capture and displayed on the display as a virtual position overlaid with the image and/or video capture. Consequently, the suction box, which is not actually visible in reality, is made virtually visible on the display. The display and/or the computing unit (2) can now be particularly configured so that an operator can change the virtual position of the suction box by shifting it. The shifting of the virtual position of the suction box on the display can, for example, be done via gesture control. This is easily possible with the touch-display displays of current mobile phones or tablets. Moreover, even inexperienced operators from a non-professional background will be familiar with this gesture control. Consequently, this shifting of the virtual position can also be carried out without detailed knowledge of the functionality of the component.

The metadata in the form of settings suitable for achieving this shift in the adjustment device is then displayed on the display. The display can be very detailed in this case. In particular, the image and/or video capture of the component can be provided with optical indications of exactly where on the adjustment device certain adjustments should be made. Incorrect operation can be largely avoided in this case.

### Application 2: Suction Rollers—Virtual Adjustment of the Sealing Strips

It may be provided that the component is a suction roller. A suction roller of this kind has a suction box inside it. The suction zone of this suction box does not extend up to the roller edges on the drive and operator sides, as these edges are not covered by the paper web during operation, and the suction of false air is to be avoided.

However, several different products are customarily manufactured on a paper machine. This also changes the current width of the respective paper web, e.g. due to different shrinkage behavior. In order to account for this, special sealing elements, so-called format limiters, are provided in the suction roller. By moving these format limiters, the width of the suction zone can be adjusted. However, these format limiters are usually not easily recognizable from the outside, making exact positioning difficult. It is known from the prior art, in particular from EP 2 707 544, for the format limiters to be provided with signal transmitters such as lasers, for example, to make the format limiters visible through the roller shell. However, installing these signal transmitters involves costs; in addition, if the roller is dirty, the signal may not always be reliably recognized on occasions.

In addition, an adjustment device for setting the position of the format limiters is provided on the suction roller.

For the adjustment, the actual values of the position of the suction box are determined based on the image and/or video capture and displayed on the display as a virtual position overlaid with the image and/or video capture. Therefore, the format limiters, which are usually not visible in reality, are made virtually visible on the display. The display and/or the computing unit (2) is now particularly configured in such a manner that an operator can change the virtual position of one or more format limiters by shifting them. The shifting of the virtual position of the format limiter on the display can take place via gesture control, for example. This is easily possible with the touch-display displays of current mobile phones or tablets. Moreover, even inexperienced operators from a non-professional background are familiar with this gesture control. Consequently, this shifting of the virtual position can also be carried out without detailed knowledge of the functionality of the component.

The metadata in the form of settings suitable for achieving this shift in the adjustment device is then displayed on the display. The display can be very detailed in this case. In particular, the image and/or video capture of the component can be provided with optical indications of exactly where on the adjustment device certain adjustments should be made. Incorrect operation can be largely avoided.

### Application 3: Spreader Rollers

It may be provided that the component is a spreader roller. Spreader rollers are intended to stretch the fibrous web widthways, so that crease-free running is thereby enabled. Rollers of this kind are described in German Utility Model DE 20 2005 022 053 U1, German Utility Model DE 20 2005 022 051 U1, or German Patent Application DE 50 2015 012 655, for example.

Spreader rollers usually achieve their effect through their curved shape. While the strength of the curvature is usually fixed, its position can generally be changed. Depending on whether the curvature is oriented upwards or slightly against the direction of the web travel or in the direction of web travel, the effect of the spreader roller on the web changes.

Spreader rollers usually have an adjustment device for setting this angle of inclination. However, it is not immediately apparent to the operator in which direction the angle of inclination needs to be changed to increase (or reduce) the tension. The adjustment device is often realized by a rotatable adjustment screw, and it takes some experience to judge which direction of rotation of the adjustment screw changes the angle of inclination in a desired direction. Since a qualitative assessment of the adjustment is already difficult, a quantitative assessment, i.e. how far the angle of inclination needs to be adjusted in a particular case, cannot be made without a lot of experience.

In one aspect of the method proposed herein, the actual value of the angle of inclination is determined by image analysis of the image and/or video capture of the exterior of the spreader roll.

Depending on the desired change in the angle of inclination, the settings of the adjustment device suitable for achieving this change can be displayed on the display.

In a preferred embodiment, the displayed metadata can be purely qualitative. So, for example, the operator can specify ‘increase tension’ as the goal, and the metadata will indicate the direction in which the angle of inclination must be changed (e.g. “counterclockwise”) or the direction in which the adjustment device must be turned (“turn the adjustment screw clockwise”). The advantage of this embodiment is that the qualitative information can usually be derived purely from the geometry and installation situation of the spreader roller by the computing unit, without requiring information on the current production (web speed, web tension, etc.) for this purpose. Metadata of this kind can therefore also be provided if there is no connection to a database system or if the connection to this database system is temporarily interrupted.

In another preferred embodiment, the displayed metadata may also include quantitative information. For example, the operator can specify ‘increase tension by 5%’ as the goal, and the metadata will indicate the direction and amount by which the angle of inclination must be changed (e.g. “5° counterclockwise”) or the direction and amount by which the adjustment device must be turned (“two turns of the adjustment screw clockwise”).

In order to ensure that this quantitative information is of good quality, it is usually necessary for the computing unit to be connected to a database system, as the determination of this metadata typically requires information on the current production (web speed, web tension, etc.) in addition to the geometry and installation situation of the spreader roll.

### Application 4: Pick-Up Rollers

In order to transfer a fibrous web from the forming section to the press section, it is typically transferred from the supporting forming fabric to a press felt. This is usually done by using a suction roller, known as a pick-up roller. A pick-up (suction) roller of this kind is described, for example, in German Patent Application DE 199 29 888 A. In order to remove the web, the pick-up roller is moved over an adjustment device, so that it dips slightly into the forming fabric. Up to this point, the positioning of the roller has been based on the operator's experience. In this case, neither exact positioning nor repeatability is ensured. Through the use of the image and/or video capture, the precise position of the roller can be determined, and based on that, appropriate settings for the adjustment device can be displayed on the display.

In particular, it may be advantageous if a database system is provided, and the computing unit can access values stored in the database system for setting the adjustment device, in order to determine the suitable settings. These could be, for example, historical values that were already used in previous productions of the same type, etc. It is also particularly advantageous for this purpose, if the computing unit is configured in such a way that the actual value of the operating state can be saved in the database system.

### Application 5: Scrapers

Other components to which a method according to aspects of the invention can be applied include scrapers, in particular crepe scrapers used in the production of tissue paper. These scrapers usually have adjustment devices to change the angle of attack of the scraper and/or the distance from the Yankee cylinder. These parameters are important for the creping result. Until now, the experience of the operating personnel has been indispensable for this purpose, as the settings are sometimes made based on what can be heard using the sounds of the scraper.

By capturing an image of the scraper, the angle and/or distance of the scraper from the cylinder can be determined and displayed as metadata on the display.

It is also advantageous that a comparison with data from a database system can also display a suggestion for a changed setting of the scraper on the display.

The presented examples are meant to demonstrate that methods according to aspects of the present invention can be used for a variety of applications. However, in this case the invention is not limited to the applications shown herein.

Further metadata that can be displayed in methods according to aspects of the present invention can also include descriptions of the various control elements. In particular, AR can be used to display the name and function of control elements, in order to prevent confusion.

Conventional labeling plates become dirty over time or even detach from the component. This can be prevented by displaying the information on the display.

Other features which are considered as characteristic for the invention are set forth in the appended claims.

Although the invention is illustrated and described herein as embodied in a method for adjustment of a component, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, top-plan view of a device with a component that can be adjusted by using a method according to one aspect of the invention;

FIG. 2 is a side-elevational view of the device from FIG. 1; and

FIG. 3 is a perspective view showing a computing unit for carrying out a method according to another aspect of the invention.

### DETAILED DESCRIPTION OF THE INVENTION

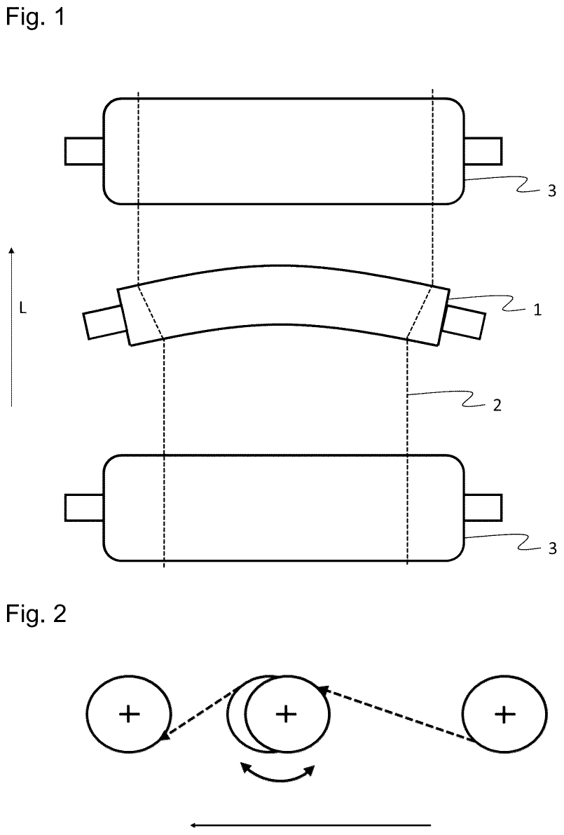

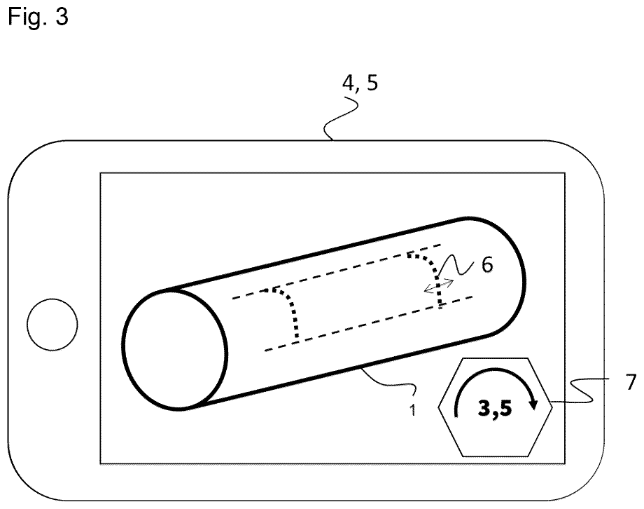

Referring now to the figures of the drawings in detail and first, particularly, to FIG. 1 thereof, there is seen a fibrous web 2 that is guided in the running direction L over two guide rollers 3. Between the two guide rollers 3 is a spreader roller 1. The spreader roller 1 is usually curved in this case. This curvature produces the spreading effect on the fibrous web 2. In FIG. 2, this device can be seen from the side. An angle adjustment of the spreader roller 1 causes the plane in which the curved axis lies to rotate. This changes the stretching (or, in other applications, compressing) effect that the spreader roller 1 has on the fibrous web 2. The curvature of the axis of the spreader roller axis 1 is greatly exaggerated in the figures. In practice, this curvature is hard to see with the naked eye, especially when the plant is in operation, and the spreader roller 1 is largely covered by the fibrous web 2. In addition, it takes a lot of experience for the operator to judge whether an angle adjustment clockwise or counterclockwise will produce the desired effect, e.g. increasing the tension.

FIG. 3 shows by way of example a computing unit 4 in the form of a smartphone 4 or tablet 4. A device of this kind is very suitable for carrying out methods according to aspects of the invention, as it combines the important elements for the method in one device, including the computing unit 4, the display 5, and the image capture via the built-in camera. For example, if the component 1 is a suction roller 1, as shown in FIG. 3, actual values of the position of the sealing strips and/or format limiters can be displayed on the display as virtual positions 6 overlaid with the image and/or video capture. The operating personnel can shift the virtual positions 6 of the sealing strip or the format limiter on the display via the touch-sensitive display 5. The settings of the adjustment device suitable for achieving this shift can then be displayed as metadata 7 on the display. This allows for simple and intuitive positioning of the sealing strips and format limiters, even for inexperienced operating personnel. The risk of incorrect settings is thereby largely avoided.

The following is a summary list of reference numerals and the corresponding structure used in the above description of the invention:
1 Component, spreader roller, suction roller
2 Fibrous web
3 Guide roller
4 Computing unit
5 Display
6 Virtual position
7 Metadata
L Running direction

1. A method for adjusting a component for a machine for the production or processing of a fibrous web, the component including at least one adjustment device for setting an operating state of the component, the method comprising:
carrying out at least one of an image capture or a video capture of an exterior of the component and transmitting the capture to a computing unit;
determining an actual value of an operating state using the computing unit by at least one of analyzing at least one of the image capture or the video capture of the exterior of the component or acquiring values from an embedded sensor system; and
based on the determined actual values of the operating state, presenting metadata for adjusting the adjustment device by overlaying the adjustment device with at least one of the image capture or the video capture on a display.

2. The method according to claim 1, which further comprises using a functional roller as the component.

3. The method according to claim 1, which further comprises attaching a marker element to the exterior of the component or in an immediate vicinity of the exterior of the component, and capturing the marker element during at least one of the image capture or the video capture.

4. The method according to claim 1, which further comprises providing a database system, and using the computing unit to access the database system to determine the metadata.

5. The method according to claim 4, which further comprises storing the actual value of the operating state in the database system.

6. The method according to claim 1, which further comprises:
providing a suction roller as the component, the suction roller having a suction box inside the suction roller as well as an adjustment device for setting a position of the suction box;
determining actual values of the position of the suction box and displaying the actual values of the position of the suction box on the display as a virtual position overlaid with at least one of the image capture or the video capture; and
configuring at least one of the display or the computing unit so that upon a shift of the virtual position of the suction box on the display, or a gesture control, settings of the adjustment device suitable for achieving the shift are displayed on the display.

7. The method according to claim 1, which further comprises:
providing a suction roller as the component, the suction roller having an adjustment device for setting a position of at least one of sealing strips or format limiters;
displaying actual values of the position of at least one of the sealing strips or format limiters are on the display as virtual positions overlaid with at least one of the image capture or the video capture; and
configuring at least one of the display or the computing unit so that upon a shift of the virtual position of at least one of the suction box or the format limiter on the display, or a gesture control, the settings of the adjustment device suitable for achieving the shift are displayed on the display.

8. The method according to claim 1, which further comprises:
providing a spreader roller as the component, the spreader roller having an adjustment device for setting an angle of inclination;
determining an actual value of the angle of inclination; and
depending on a desired change in the angle of inclination, displaying settings of the adjustment device suitable for achieving the desired change on the display.

9. The method according to claim 1, which further comprises:
providing a pick-up roller as the component, the pick-up roller having an adjustment device for positioning the pick-up roller or for positioning the pick-up roller relative to a forming fabric;
determining an actual value of the position of the pick-up roller; and
displaying suitable settings of the adjustment device on the display.

10. The method according to claim 9, which further comprises providing a database system, and using the computing unit to access values stored in the database system for setting the adjustment device.
